(19) United States
(12) Patent Application Publication
(10) Pub. No.: US 2004/0070780 A1
(43) Pub. Date: Apr. 15, 2004

(54) Color image communication device

(75) Inventor: Osamu Kimoto, Uji-shi (JP)

Correspondence Address: HOGAN & HARTSON L.L.P., 500 S. GRAND AVENUE, SUITE 1900, LOS ANGELES, CA, 90071-2611, US

(73) Assignee: Murata Kikai Kabushiki Kaisha

(21) Appl. No.: 10/652,983

(22) Filed: Aug. 28, 2003

(30) Foreign Application Priority Data
Oct. 11, 2002 (JP) 2002-298305
May 20, 2003 (JP) 2003-141271

(51) Int. Cl. G06F 3/12; G06F 13/00; H04N 1/50; H04N 1/64

(52) U.S. Cl. 358/1.13; 358/1.15; 358/500; 358/3.24

(57) ABSTRACT

A color image communication device includes a transmission unit which can transmit color image data to a recipient under a first method and a second method, and a control unit which determines whether to transmit the color image data under the first method or whether to transmit under the second method in accordance with a determination of whether or not to print out the color image data at the recipient.

### BACKGROUND OF THE INVENTION

1. Field of the Invention

The present invention relates to a color image communication device such as a facsimile machine, a multifunction peripheral or the like which can support a CIELAB color method and as (standard)YCC color method.

2. Description of the Related Art

A proposal for a new color facsimile protocol has been recently discussed on the international level. In the discussion, a color method having a CIELAB color space, and a color method having a sYCC color space were discussed. A color facsimile machine, which handles the sYCC color method and the CIELAB color method, is known.

When assuming a case in which a transmitter in a facsimile communication is attempting to transmit color image data of a sYCC color space and a recipient can support both the sYCC color space and the CIELAB color space, it is preferable for the recipient to switch to a color method (color space) to receive the color image data according to whether or not to print out the color image data. That is, it is extremely convenient if the color image data of the color space suitable for printing is transmitted from the transmitter in case of printing the color image data at the recipient, and if the color image data of the color space other than the color space suitable for printing is transmitted from the transmitter in case of not printing the color image data at the recipient.

### SUMMARY OF THE INVENTION

The present invention was made in consideration to the above-described problems. An advantage of the present invention is to provide a color image communication device and a color image communication method which can transmit color image data by selecting an appropriate color method according to whether or not to print the color image data at a recipient when a facsimile machine of the recipient can support both a first method (CIELAB color space) and a second method (sYCC color space).

The color image communication device of the present invention can carry out a facsimile transmission of color image data to a recipient under a first method (CIELAB) and a second method (sYCC). The color image communication device determines whether to carry out a facsimile transmission under the first method or whether to carry out a facsimile transmission under the second method in accordance with a determination of whether or not to print out the color image data at the recipient. For example, when the color image data to be transmitted by facsimile is the sYCC color space, and the recipient supports both the CIELAB color space and the sYCC color space, in case of printing the color image data at the recipient, CIELAB is selected as a color method to transmit the color image data, and in case of not printing the color image data at the recipient, sYCC is selected as a color method to transmit the color image data.

According to this invention, when the color image data transmitted by the transmitter is the sYCC color space, and the recipient can support both the sYCC color space and the CIELAB color space, in case of printing the color image data at the recipient, the CIELAB color method which is suitable for printing can be selected, and in case of not printing the color image data at the recipient, the sYCC color method can be selected.

Moreover, the color image communication device of the present invention includes a transmission unit which carries out a facsimile transmission of color image data as first color space data to a recipient, and another transmission unit which carries out a facsimile transmission of color image data as second color space data to a recipient. In addition, the color image communication device includes a color space conversion unit which converts color image data of the second color space into color image data of the first color space. The color image communication device also includes a confirmation unit which confirms the color space which can be supported by the recipient, and a determination unit which determines whether or not to print the transmitted color image data at the recipient. Furthermore, the color image communication device includes a switching unit which switches between a process to transmit the second color space data, and a process to convert the second color space data into the first color space data and then to transmit the first color space data, in accordance with a result of the confirmation of the color space which can be supported by the recipient and a result of the determination of whether or not to print out the color image data at the recipient.

Moreover, the color image communication device of the present invention includes an image scanning unit, an image storage unit, a forwarding unit, an image printing unit, a color space conversion unit, and a control unit. The image scanning unit optically scans an original document, and generates color image data of a Red Green Blue (RGB) color space. The image storage unit stores the color image data. The forwarding unit forwards the color image data stored in the image storage unit to a remote image processing device via a network. The image printing unit prints the color image data stored in the image storage unit onto a recording paper. The color space conversion unit converts color image data of the RGB color space into a color space according to a process to be carried out after the image is scanned. When it is selected to forward the color image data by the forwarding unit as a process to be carried out after the image is scanned, the control unit controls to convert the color image data of the RGB color space generated by the image scanning unit into the color image data of the sYCC color space, and to store the color image data of the sYCC color space in the storage unit. When it is selected to print the color image data by the image printing unit as a process to be carried out after the image is scanned, the control unit controls to convert the color image data of the RGB color space generated by the image scanning unit into color image data of the CIELAB color space, and to store the color image data of the CIELAB color space in the image storage unit.

According to this invention, when forwarding the color image data to a Personal Computer (PC) after scanning the image, the color image data of the RGB color space obtained by scanning the image can be converted into sYCC color space data, and the color image data of the sYCC color space can be forwarded to a PC on a network. Meanwhile, when recording (printing) the color image data by the image printing unit after scanning the image, the color image data of the RGB color space obtained by the scanning operation is converted into CIELAB color space data, the CIELAB color space data is converted into Cyan Magenta Yellow blacK (CMYK) color space data, and in accordance with the CMYK color space data, the color image can be recorded onto a recording paper.

### BRIEF DESCRIPTION OF DRAWINGS

FIG. 1 is a block diagram showing a configuration of a color multifunction peripheral according to an embodiment of the present invention.

FIG. 2 is a flowchart showing a transmission process of when carrying out a facsimile transmission of sYCC image data by the color multifunction peripheral.

FIG. 3 is a block diagram showing a configuration of a communication system where the color multifunction peripheral is applied.

FIG. 4 is a flowchart showing a transmission process of when carrying out a facsimile transmission of color image data by the color multifunction peripheral, and a flowchart showing a transmission process of when designating a post-reception processing function to a recipient by a F-CODE signal of a facsimile transmission control protocol.

FIG. 5 is a flowchart showing a transmission process of when carrying out a facsimile transmission of color image data by the color multifunction peripheral, and a flowchart showing a transmission process of when designating a post-reception processing function to a recipient by a calling number.

FIG. 6 shows a table to be used in a description of the flowchart of FIG. 5.

FIG. 7 is a flowchart showing a transmission process of when carrying out a facsimile transmission of color image data by the color multifunction peripheral, and a flowchart showing a transmission process of when designating a post-reception processing function to the recipient by an extension attached to a calling number.

FIG. 8 shows a table to be used in a description of the flowchart of FIG. 7.

FIG. 9 is a flowchart showing a transmission process of when carrying out a facsimile transmission of color image data by the color multifunction peripheral, and a flowchart showing a transmission process of when designating a post-reception processing function and a communication terminal device of a called destination by a dial-in number of when a call is made.

FIG. 10 shows a table to be used in a description of the flowchart of FIG. 9.

FIG. 11 is a flowchart showing a process of when a color scan function of an original document is executed by the color multifunction peripheral.

FIG. 12 is a flowchart showing a process of when a format of the received color image data is a format not suitable for the post-reception processing function.

### DETAILED DESCRIPTION OF THE PREFERRED EMBODIMENTS

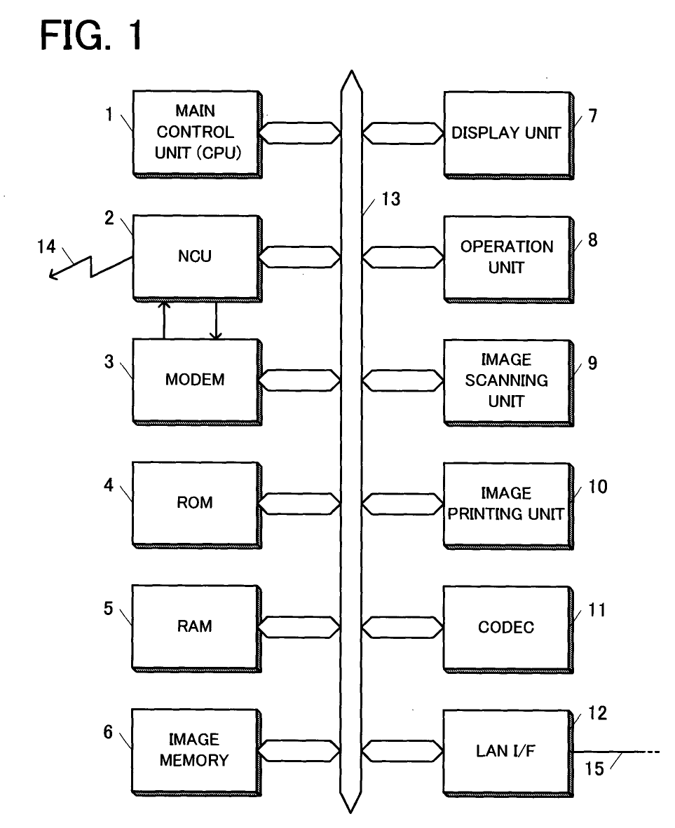

Embodiments of the present invention will be described. FIG. 1 is a block diagram showing a schematic configuration of the entire color image communication device according to an embodiment of the present invention. The color image communication device is formed as a so-called color multifunction peripheral which includes a facsimile function (color facsimile function) and a copy function. The color image communication device includes a main control unit 1, a Network Control Unit (NCU) 2, a modem 3, a Read Only Memory (ROM) 4, a Random Access Memory (RAM) 5, an image memory 6, a display unit 7, an operation unit 8, an image scanning unit 9, an image printing unit 10, a Coder and Decoder (CODEC) 11, a Local Area Network InterFace (LAN I/F) 12, and a bus 13.

The main control unit (Central Processing Unit (CPU)) 1 includes a function for controlling each of the units of the color image communication device. The NCU 2 controls a connection established with a Public Switched Telephone Network (PSTN) 14 which is a communication network. In addition, the NCU 2 includes a function for transmitting a dial signal corresponding to a telephone number (including a facsimile number) of a destination, and a function for detecting an incoming call. The modem 3 modulates transmission data and demodulates received data in accordance with V.17, V.27ter, V.29 or the like, based on a facsimile transmission control protocol (facsimile communication protocol) following the International Telecommunication Union-Telecommunications (ITU-T) Recommendations T.30, T.4. In addition, the modem 3 also modulates transmission data, and demodulates received data in accordance with V.34.

The ROM 4 stores programs for controlling the color image communication device. The RAM 5 temporarily stores data or the like that generate when the program stored in the ROM 4 is executed. In addition, the RAM 5 includes storage units which are assigned to store CIELAB image data and sYCC image data. The CIELAB image data and the sYCC image data are stored in the RAM 5 by being compressed under a Joint Photographic Experts Group (JPEG) method or the like.

The image memory 6 temporarily stores received image data or image data scanned by the image scanning unit 9. The display unit (Liquid Crystal Display (LCD)) 7 displays icons and key buttons, and displays messages which are necessary for transmitting and receiving data. The operation unit 8 includes one-touch keys, an enter key, an operation mode switching key, a ten-key numeric pad, a start key, and other various keys. The operation mode switching key is a key for switching operation modes between a plurality of operation modes such as a FAX mode, a copy mode, a scanner mode or the like.

The image scanning unit 9 optically scans and reads an image of an original document when carrying out a facsimile transmission or when copying. The image scanning unit 9 can read both a color original document and a monochrome original document. When reading a color original document, the image scanning unit 9 optically scans the image of the original document to obtain an image scan signal which is separated into colors of Red, Green, and Blue (RGB). The RGB color space data, which is obtained by reading a color original document, is converted into a CIELAB color space data or an sYCC color space data when necessary. Therefore, the color image communication device includes a conversion unit which converts the RGB color space data into the CIELAB color space data, and another conversion unit which converts the RGB color space data into the sYCC color space data. In addition, the color image communication device includes another conversion unit which converts the sYCC color space data into the CIELAB color space data.

The image printing unit 10 is formed from an electro-photographic typed printer, and prints out onto a recording paper, received image data or image data of an original document scanned by the image scanning unit 9 in a copy operation. The image printing unit 10 uses toner of four colors, Cyan, Magenta, Yellow, and blacK (CMYK). The image printing unit 10 can carry out monochrome printing using only blacK (K) toner, and a color printing using toner of all four colors CMYK. The CODEC 11 encodes the scanned image data under Modified Huffman (MH), Modified Read (MR), Modified Modified Read (MMR) methods or the like for transmitting or storing the image data. In addition, the CODEC 11 decodes image data received under a compressed state to print out the image data by the image printing unit 10. The LAN I/F 12 exchanges data with remote devices via a LAN 15, and the remote devices such as a Personal Computer (PC) are connected to the color image communication device via the LAN I/F 12. For example, the color image communication device receives sYCC image data under a compressed state from a remote device via a network, and stores the received sYCC image data in a storage unit of the RAM 5. Moreover, when receiving a request to forward the image data from the remote device via the network, the color image communication device fetches the sYCC image data previously stored in the storage unit of the RAM 5, and transmits the image data via the network to the remote device that requested the image data.

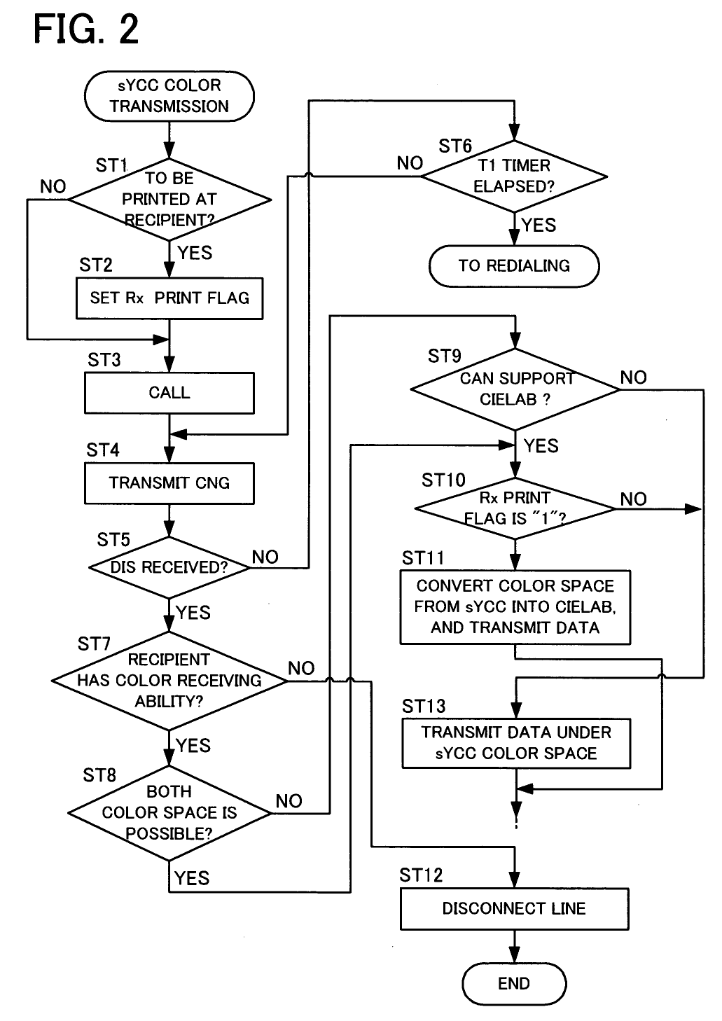

Next, by referring to the flowchart shown in FIG. 2, a transmission process of when the color multifunction peripheral of the present embodiment carries out a facsimile transmission of color image data (sYCC image data) will be described. First, in step ST1, it is determined whether or not to print out the transmitted color image data at a recipient. For example, a setting of whether or not to print out the color image data at the recipient can be carried out by the color multifunction peripheral by an inputting operation of the user from the operation unit 8. The setting of whether or not to print out the color image data at the recipient can be set in common for all transmission jobs in advance, or can be set individually for each transmission job. Moreover, the setting of whether or not to print out the color image data at the recipient can be carried out by the color multifunction peripheral in accordance with a facsimile transmission control protocol transmitted from the recipient. When printing out the color image data at the recipient, the process proceeds to step ST2. Meanwhile, when not printing out the color image data at the recipient, step ST2 is skipped, and the process proceeds to step ST3. In step ST2, after setting reception (RX) print flag, the process proceeds to step ST3.

In step ST3, a call is made to the recipient. Then, the process proceeds to step ST4. In step ST4, a calling tone (CNG) signal is transmitted. Next, the process proceeds to step ST5. In step ST5, it is determined whether or not a Digital Identification Signal (DIS) is received from the recipient. The DIS signal is one of the facsimile transmission control protocols, and includes information relating to the function or ability of a recipient device. When no DIS signal is received, the process proceeds to step ST6. Meanwhile, when a DIS signal has been received, the process proceeds to step ST7. In step ST6, it is determined whether or not a T1 timer (set when a call is made) has an elapsed set time. When the set time has not elapsed yet, the process returns to step ST4. Then, until the set time elapses, or until receiving a DIS signal, the process to transmit a CNG signal and the process of steps ST5, ST6 are repeated. When the T1 timer elapses the set time, a dial is made again.

In step ST7, it is determined whether or not the recipient has color receiving ability (whether or not a facsimile reception of color image data can be carried out) in accordance with the DIS signal received in step ST5. When the recipient does not have a color receiving ability, the process proceeds to step ST12. Meanwhile, when the recipient has a color receiving ability, the process proceeds to step ST8. In step ST12, a communication line is disconnected, and the transmission process ends. In step ST8, it is determined whether or not the recipient can receive color image data under color methods of both the sYCC color space and the CIELAB color space in accordance with the DIS signal received in step ST5. When the recipient can receive the color image data under both color spaces, the process proceeds to step ST10. Meanwhile, when the recipient does not support one of the color spaces, the process proceeds to step ST9.

In step ST9, it is determined whether or not the recipient can support the CIELAB color space among the two color spaces (whether or not a facsimile reception of the CIELAB image data can be carried out). The determination in step ST9 is carried out in accordance with the DIS signal received in step ST5. When it is determined that the recipient can support the CIELAB method in step ST9, the process proceeds to step ST10. Meanwhile, when it is determined that the recipient cannot support the CIELAB method, the process proceeds to step ST13. In step ST10, it is determined whether or not the RX print flag is “1”, in other words, whether or not the RX print flag is set. When the RX print flag is set, it means that the recipient wishes to print out the color image data. Therefore, the process proceeds to step ST11. Meanwhile, when the RX print flag is not set, it means that the recipient is not wishing to print out the color image data. Therefore, the process proceeds to step ST13.

Since it is confirmed in step ST10 that the RX print flag is set and that the color image data will be printed out at the recipient, in step ST11, the color space is converted from the sYCC color space into the CIELAB color space that is suitable for the printing process, and the data is transmitted. By carrying out a facsimile transmission under the CIELAB color space, the recipient which received this data can easily carry out a process for printing out the data. When carrying out the facsimile transmission, the CIELAB image data is transmitted under a compressed state (as CIELAB-JPEG data). Moreover, in step ST13, the facsimile transmission is carried out under the sYCC color space since it is determined in step ST9 that the recipient cannot support the CIELAB method, or it is determined in step ST10 that the RX print flag is not “1”, in other words, when the recipient will not print out the color image data. Also when carrying out the facsimile transmission in this case, the sYCC image data is transmitted under compressed state (as sYCC-JPEG data).

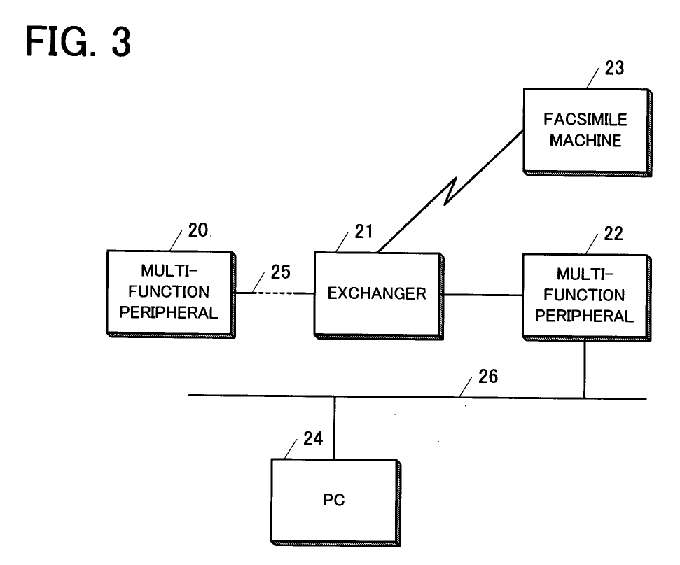

Next, another embodiment of the present invention will be described. FIG. 3 is a block diagram showing a configuration of a communication system where the present invention is practiced. Here, it is assumed for a first case and a second case of that a facsimile transmission of a color image is carried out from a multifunction peripheral 20 to a multifunction peripheral 22 via a public line 25 and an exchanger 21. In the first case, the multifunction peripheral 22 prints out the color image received by a facsimile by a color printer provided in the multifunction peripheral 22. In the second case, the multifunction peripheral 22 forwards the color image received by a facsimile to a remote device (PC 24) via a network (IAN 26) without printing out the color image.

As an easiest processing method (first method) to switch between the first case and the second case, there is a method to allow a user of the multifunction peripheral 20 to select a case to print out the color image data by the multifunction peripheral 20, or a case to forward the color image data to the PC 24. Under the first method, when carrying out a facsimile transmission of the color image data, in case a mode A to print out the color image data by the multifunction peripheral 22 is selected, the image data of the CIELAB color space is transmitted from the multifunction peripheral 20 to the multifunction peripheral 22. Moreover, when a mode B to forward the color image data to the PC 24 without printing out the color image data by the multifunction peripheral 22 is selected, the image data of the sYCC-JPEG color space is transmitted from the multifunction peripheral 20 to the multifunction peripheral 22. In the multifunction peripheral 20 of the transmitter, a setting to switch between mode A and mode B can be set in common for all transmission jobs in advance. Moreover, the setting to switch between mode A and mode B can be set individually for each transmission job.

As another processing method (second method) to switch between the first case and the second case, there is a method to store post-reception processing functions (printing function, PC forwarding function) in the storage unit of a transmitter device (multifunction peripheral 20), by associating each of the post-reception processing with each storage BOX number of a plurality of storage BOXes of the multifunction peripheral 22. Each of the storage BOXes respectively corresponds to a storage field for the recipient device to store the received image data. The storage BOX number can be designated by one type of the facsimile transmission control protocols, a so-called F-CODE signal. The F-CODE signal is a signal which is transmitted from the transmitter (multifunction peripheral 20) along with a Digital Command Signal (DCS) signal which is one type of the facsimile transmission control protocols. The F-CODE signal includes SUB (subaddress: 20 digits number) and PWD (passwords: 20 digits number).

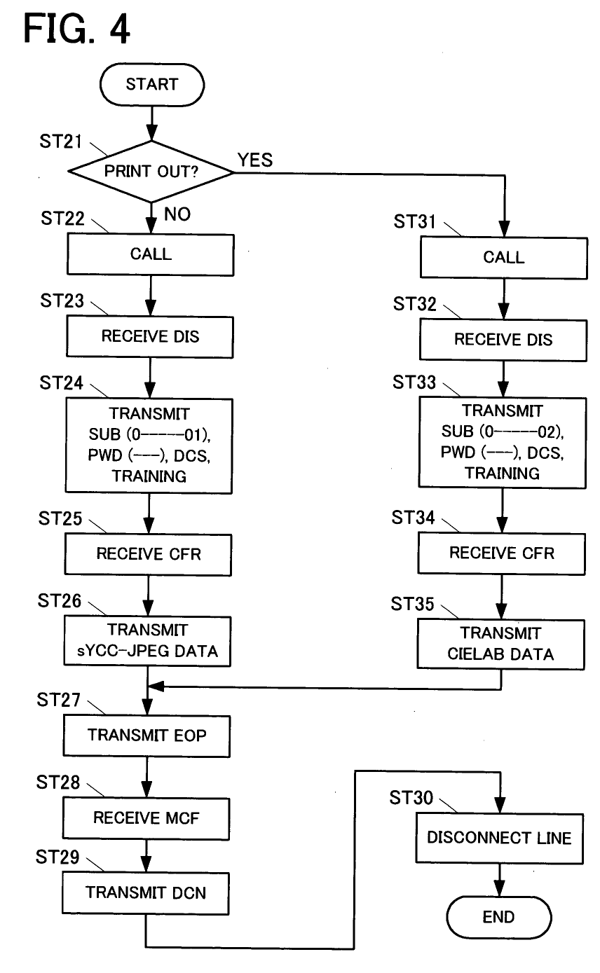

In the first method and/or the second method, a transmission process as shown in FIG. 4 is executed in the multifunction peripheral 20 which is a transmitter. FIG. 4 is a flowchart showing a transmission process of when carrying out a facsimile transmission of color image data. First, in step ST21, it is determined whether to print out the color image data at the recipient, or to forward the color image data to a PC. For example, the determination in step ST 21 can be carried out in accordance with a selection operation of the user. When printing out the color image data at the recipient, the process proceeds to step ST31. Meanwhile, when forwarding the color image data to the PC at the recipient, the process proceeds to step ST22. In step ST22, a call is made to the recipient, and the process proceeds to step ST23. In step ST23, a DIS signal, which is a signal indicating a standard ability of a called device (recipient), is received. Next, the process proceeds to step ST24.

In step ST24, a subaddress signal SUB (0, . . . 0, 1), a password PWD ( . . . ), and a DCS signal are transmitted, and a training transmission is carried out. Here, 0, . . . 0, 1 of the subaddress signal SUB correspond to the BOX (0, . . . 0, 1) of the multifunction peripheral 22, and PC forwarding function is designated as the post-reception processing function. Next, the process proceeds to step ST25. In step ST25, a Confirmation to Receive (CFR) signal is received. Next, the process proceeds to step ST26. In step ST26, sYCC-JPEG data is transmitted as color image data of the color space which is suitable for PC forwarding. Then, the process proceeds to step ST27, and an End of Procedure (EOP) signal is transmitted. Next, the process proceeds to step ST28, and a Message Confirmation (MCF) signal is received. Then, the process proceeds to step ST29, a Disconnect (DCN) signal is transmitted, and the communication line is disconnected in step ST30.

Meanwhile, in step ST 31 which is a processing of when printing out the color image data at the recipient, a call is made to the recipient in the same manner as in step ST22. Next, in step ST32, a DIS signal is received, and the process proceeds to step ST33. In step ST33, a subaddress SUB (0, . . . 0, 2), a password PWD ( . . . ), and a DCS signal are transmitted, and a training transmission is carried out. Here, 0, . . . , 0, 2 of the subaddress signal SUB correspond to the BOX (0, . . . , 0, 2) of the multifunction peripheral 22, and a printing function is designated as a post-reception processing function. Next, the process proceeds to step ST34. In step ST34, a CFR signal is received. Next, the process proceeds to step ST35. In step ST35, the CIELAB data is transmitted as color image data of the color space suitable for printing. Then, the process proceeds to step ST27. The processes of step ST27 and after are as described above.

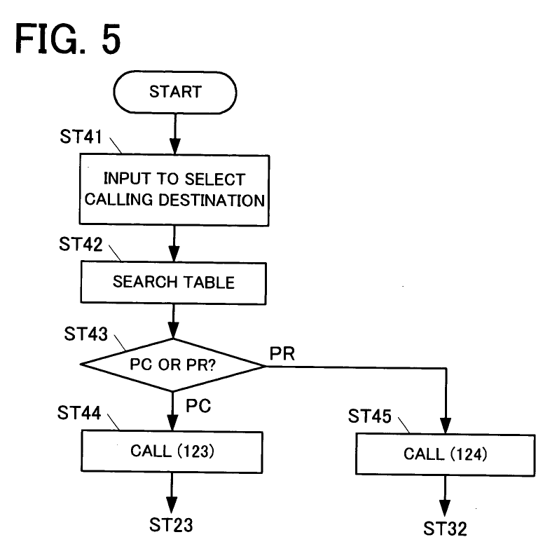

Next, as another processing method (third method) which designates a post-reception processing function to the recipient, a processing method shown in FIG. 5 will be described. FIG. 5 shows a process of when designating a post-reception processing function by using a calling facsimile number in case two facsimile numbers are given to the multifunction peripheral 22 which is a recipient device. In the third method shown in FIG. 5, one of the numbers 123 is called when forwarding the color image data to the PC at the recipient, and the other number 124 is called when printing out the color image data at the recipient.

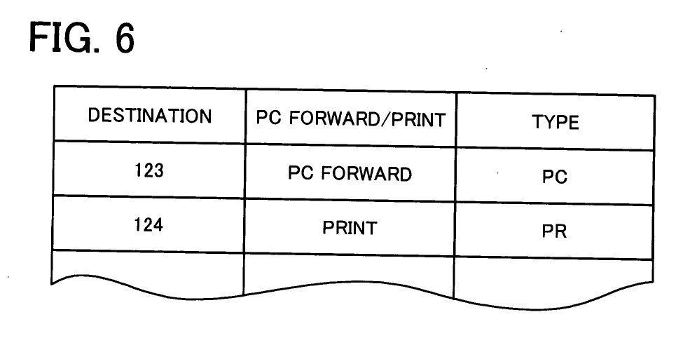

The multifunction peripheral 20, which is a transmitter of when realizing the third method, stores in the RAM 5, a table which associates numbers selected by an operation for selecting a calling destination with a post-reception processing function (PC forward/print). As shown in FIG. 5, when the user inputs to select a calling destination in step ST41, the process proceeds to step ST42. In step ST42, a table is referenced, and a post-reception processing function is selected in accordance with the input number. An example of the table is shown in FIG. 6. As shown in FIG. 6, destination, post-reception processing function (PC forward/print), and type code are stored in the table and associated with one another. For example, when the input facsimile number is 123, PC forward is fetched as the post-reception processing function, and PC is fetched as the type. Moreover, when the input facsimile number is 124, print is fetched as the post-reception processing function, and PR is fetched as the type. Next, the process proceeds to step ST43.

In step ST43, it is determined whether the type fetched in step ST42 is PC or PR. When the type is PC, the process proceeds to step ST44. Meanwhile, when the type is PR, the process proceeds to step ST45. In step ST44, the facsimile number 123 is called. Moreover, in step ST45, the facsimile number 124 is called. When the type is PC, after the process of ST44, the process proceeds to step ST23 of FIG. 4, and the transmission process of the sYCC-JPEG data is executed thereafter according to the processing described in FIG. 4. Meanwhile, when the type is PR, after the process of step ST45, the process proceeds to step ST32 of FIG. 4, and the transmission process of the CIELAB data is executed thereafter according to the processing described in FIG. 4.

When receiving transmission data by a call made to the facsimile number 123, the multifunction peripheral 22 of the recipient forwards the data as a post-reception process. When receiving transmission data by a call made to the facsimile number 124, the multifunction peripheral 22 prints out the data by a color printer of the multifunction peripheral 22 itself as a post-reception process.

Furthermore, as another processing method (fourth method) which designates a post-reception processing function to the recipient, there is a method to transmit color image data by attaching an extension to the facsimile number according to the post-reception processing function. Under the fourth method, when forwarding the color image data to a PC at the recipient, an extension corresponding to PC forward is attached, and the color image data is transmitted. Moreover, when printing out the color image data, an extension corresponding to print is attached, and the color image data is transmitted.

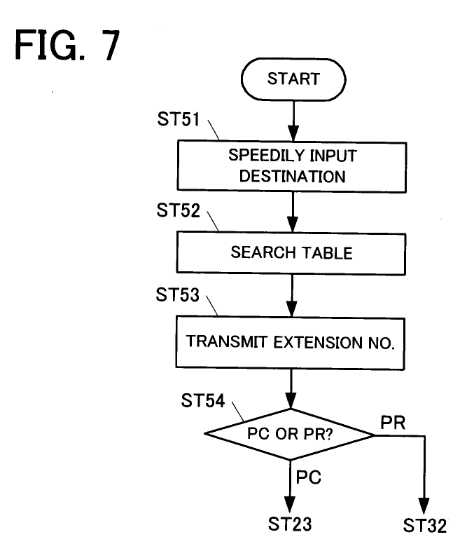

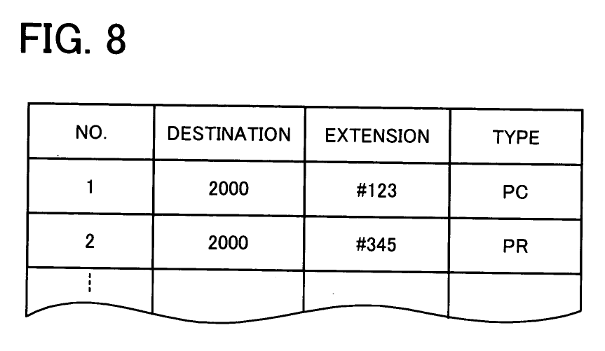

In the case of the fourth method, the multifunction peripheral 20 of the transmitter stores in the RAM 5, a table which associates contents of a destination input speedily, and a post-reception processing function. In this case, as shown in FIG. 7, first in step ST51, the user speedily inputs a destination (one-touch key operation) according to whether to forward the color image data to a PC or whether to print out the color image data after the reception. An extension is selected according to the contents of the destination input speedily. Next, the process proceeds to step ST52. In step ST52, a table is referenced, and a post-reception processing function is selected in accordance with the input of the destination carried out in step ST51. An example of the table to be used is shown in FIG. 8. The number to be input speedily for the destination, destination (facsimile number), extension, and type codes are stored in the table shown in FIG. 8 by being associated with one another. For example, for the speedily input number “1”, a destination “2000”, an extension “#123”, and a type “PC” are stored. When the speedily input number “1” is input, the destination “2000”, the extension “#123”, and the type “PC” are fetched. Next, the process proceeds to step ST53. In step ST53, an extension number is attached to a destination number (facsimile number), and transmitted to the recipient. Next, the process proceeds to step ST54.

In step ST54, it is determined whether the type fetched from the table is PC or PR. When the type is PC, the process proceeds to step ST23 of FIG. 4, and the transmission process of the sYCC-JPEG data is executed thereafter according to the process described in FIG. 4. Meanwhile, when the type is PR, the process proceeds to step ST32 of FIG. 4, and the transmission process of the CIELAB data is executed thereafter according to the process described in FIG. 4.

The multifunction peripheral 22 of the recipient determines a process (post-reception processing function) to be executed to the received color image data in accordance with the contents of the received extension attached to a destination number. For example, the color image data received along with the extension “#123” is forwarded to a PC, and the color image data received along with the extension “#124” is printed out by the printer of the multifunction peripheral 22.

Furthermore, as another processing method (fifth method) which designates a post-reception processing function to the recipient, there is a method wherein in a system where a plurality of communication terminal devices are connected to a same communication line, when a dial-in number is assigned individually to each of the communication terminal devices, a communication terminal device of a calling destination is designated by a dial-in number of when a call is made. When the post-reception processing function of each of the communication terminal devices is respectively specified in advance, the post-reception processing function can be designated by designating a communication terminal device of a calling destination. For example, in the system shown in FIG. 3, the multifunction peripheral 22 and the facsimile machine 23 are connected to the same public line 25, and the exchanger 21 switches a device which is to be a calling destination according to a dial-in number being transmitted. In the system shown in FIG. 3, when calling from the multifunction peripheral 20, in case of forwarding the color image data to a PC at the recipient, the multifunction peripheral 22 is dialed directly, and in case of printing out the color image data at the recipient, the facsimile machine 23 can be dialed directly.

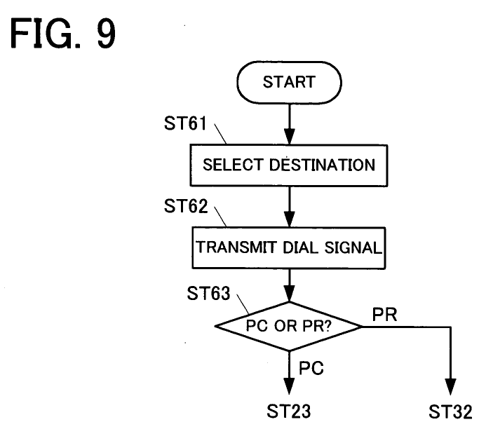

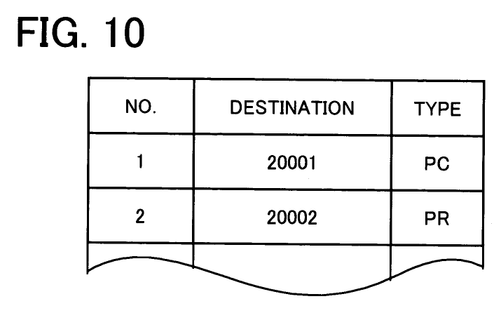

The fifth method will be described with reference to FIG. 9. Under the fifth method, the multifunction peripheral 20 which is a transmitter selects a destination in step ST61. In other words, the user of the multifunction peripheral 20 selects and inputs a dial-in number corresponding to a calling destination of the recipient. For example, when forwarding the color image data to the PC at the recipient, the multifunction peripheral 22 is selected as the destination. Meanwhile, when printing out the color image data at the recipient, the facsimile machine 23 is selected as the destination. The destination can be selected and input by an operation of a one-touch key. Next, the process proceeds to step ST62. In step ST62, a dial signal corresponding to the selected destination is transmitted. The multifunction peripheral 20 stores in the RAM 5, the table shown in FIG. 10. The table shown in FIG. 10 stores a destination number (calling number) and type code by associating to the one-touch key number. For example, when a one-touch key “1” is operated to select a destination, a destination number 20001 is transmitted as a dial signal. Then, the process proceeds to step ST63.

In step ST63, a table is reference, and it is determined whether the type of the selected destination is PC or PR in accordance with the selected one-touch key. When the type is PC, the process proceeds to step ST23 of FIG. 4, and the transmission process of the sYCC-JPEG data is executed thereafter according to the process described in FIG. 4. Meanwhile, when the type is PR, the process proceeds to step ST32 of FIG. 4, and the transmission process of the CIELAB data is executed thereafter according to the process described in FIG. 4.

When receiving transmission data (color image data) addressed to the multifunction peripheral 22 itself, the multifunction peripheral 22 forwards the received image data to the PC via the network. Moreover, when receiving transmission data (color image data) addressed to the facsimile machine 23 itself, the facsimile machine 23 prints out the received image data by using a color printer of the facsimile machine 23 itself.

The multifunction peripheral 20 can scan a color original document by a color scan function of the image scanning unit 9. The color image data obtained by the scanning operation of the image scanning unit 9 is converted into data of the CIELAB color space. Then, the color image data is stored into the image memory 6 under a format of the CIELAB-JPEG color space. Moreover, the multifunction peripheral 20 can retrieve color image data photographed by a digital camera via a data transfer interface (for example, a Universal Serial Bus (USB)). The color image data retrieved via the USB or the like is stored in another field of the image memory 6 under a format of the sYCC-JPEG color space.

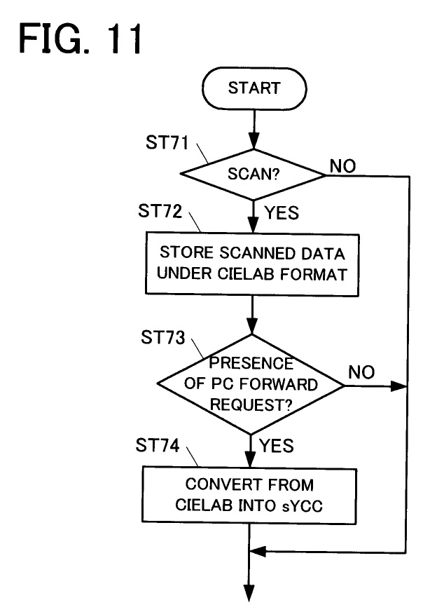

FIG. 11 shows a process of a multifunction peripheral wherein when executing a color scan function to scan an original document, color image data is stored under the CIELAB format, and when forwarding the color image data to a PC, the color image data is transmitted after the color space is converted into the sYCC format. As shown in FIG. 11, in step ST71, it is determined whether or not to scan an original document. When it is determined YES, the process proceeds to step ST72. In step ST72, the color image data obtained by the scanning operation is stored into the image memory 6 under the CIELAB format. Next, the process proceeds to step ST73.

In step ST73, it is determined whether or not there is a request to forward the color image data to the PC. When there is no request to forward the color image data to the PC, it returns. Meanwhile, when there is a request to forward the color image data to the PC, the process proceeds to step ST74. In step ST74, the color image data of the CIELAB-JPEG format stored in the image memory 6 is converted into sYCC-JPEG format. Further, in FIG. 11, the scan data of the RGB format is once converted into the CIELAB format, and then, when there is a request to forward the color image data to the PC, the data is converted into the sYCC format. However, when there is a request to forward the color image data to the PC, the scan data of the RGB format can be converted directly into the sYCC format without being converted into the CIELAB format.

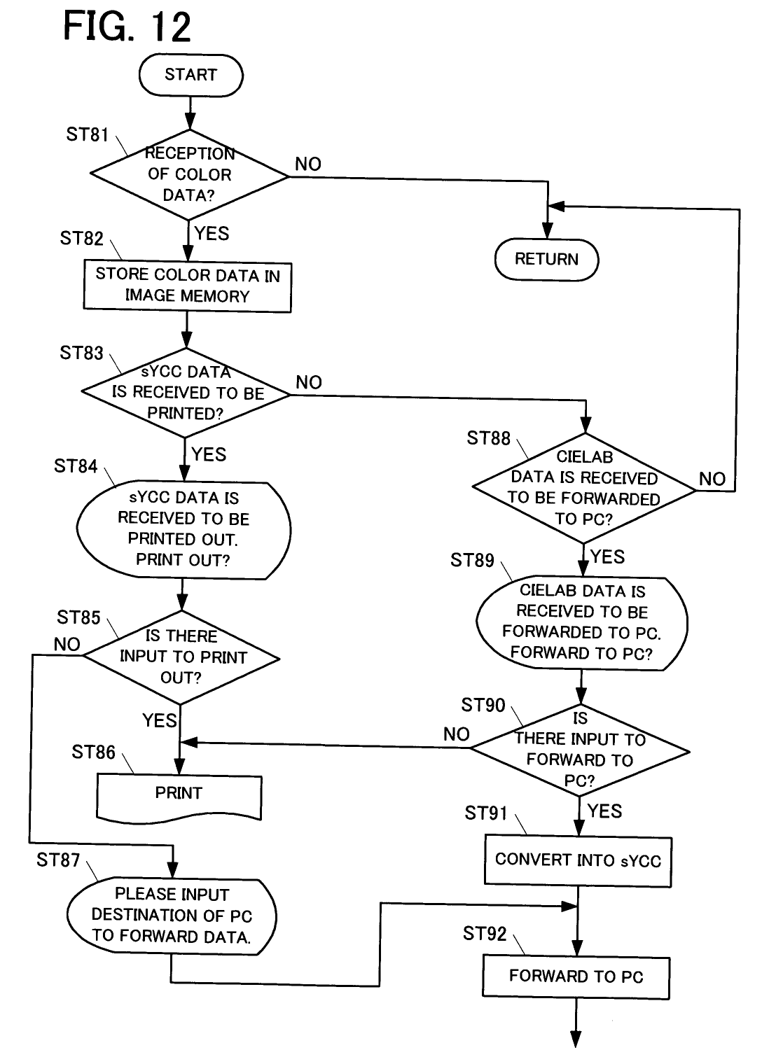

Next, referring to FIG. 12, a process of when a format (color space) of the received color image data is not a format suitable for the post-reception processing function will be described. FIG. 12 shows a process to be executed at the recipient. When receiving color image data of a format (color space) not suitable to the post-reception processing function designated by the transmitter, such a fact is notified to the user. The multifunction peripheral 22 includes a first memory (storage field) which stores the sYCC-JPEG color image received to be forwarded to a PC, and a second memory (storage field) which stores the CIELAB color image received to be printed out.

As shown in FIG. 12, in step ST81, it is determined whether or not the color image data is received. When receiving the color image data, the process proceeds to step ST82. In step ST82, the received color image data is stored in the image memory 6. Next, the process proceeds to step ST83. In step ST83, it is determined whether or not the sYCC-JPEG data is received to be printed out, and is stored in the second memory. The sYCC-JPEG data is generally received to be forwarded to a PC, and is stored into the first memory. However, when receiving the sYCC-JPEG data to be printed out by a mistake, the process proceeds to step ST84. Meanwhile, when storing the sYCC-JPEG data to be forwarded to a PC, or when receiving the CIELAB data, the process proceeds to step ST88.

In step ST84, a message “sYCC-JPEG data is received to be printed out. Print out?” is displayed on a display unit. Next, the process proceeds to step ST85. In step ST85, it is determined whether or not a print command has been input by the user. When the user looks at the message displayed on the display unit and inputs a print command via an operation unit, the process proceeds to step ST86. Meanwhile, when a print command is not input within a prescribed period of time after the message is displayed, the process proceeds to step ST87. In step ST86, the received sYCC-JPEG data is printed out. Moreover, in step ST87, a message, “Please input destination of PC to forward data”, is displayed on the display unit. When the user inputs the destination of a PC which receives the forwarded data, the process proceeds to step ST92. In step ST92, the sYCC-JPEG data stored in the memory is forwarded to the PC.

In step ST88, it is determined whether or not the CIELAB data is received to be forwarded to the PC, and stored in the first memory. The CIELAB data is generally received to be printed out, and is stored in the second memory. However, when receiving the CIELAB data to be forwarded to the PC by a mistake, the process proceeds to step ST89. Meanwhile, when the CIELAB data is received to be printed out, it returns. In step ST89, a message “CIELAB data is received to be forwarded to PC. Forward to PC?” is displayed on the display unit. Next, the process proceeds to step ST90.

In step ST90, it is determined whether or not a PC forwarding command is input. When the user looks at the message displayed on the display unit, and inputs a PC forwarding command via the operation unit, the process proceeds to step ST91. Meanwhile, when a PC forwarding command is not input within a prescribed period of time after the message is displayed, the process proceeds to step ST86. In step ST86, necessary processing is executed to the CIELAB data and printed out. Moreover, in step ST91, the received CIELAB data is converted into sYCC-JPEG data. Next, the process proceeds to step ST92, and the converted sYCC-JPEG data is forwarded to the PC.

What is claimed is:

1. A color image communication device comprising:
means for transmitting color image data under a first method and a second method to a recipient; and
means for controlling to determine whether to transmit the color image data under the first method or whether to transmit the color image data under the second method according to a determination of whether or not to print out the color image data at the recipient.

2. The color image communication device according to claim 1, wherein the means for controlling determines whether to transmit the color image data under the first method or whether to transmit the color image data under the second method according to the determination of whether or not to print our the color image data at the recipient, and a determination of whether or not the recipient supports the first method and the second method.

3. The color image communication device according to claim 2, wherein the means for controlling determines whether or not the recipient supports the first method and the second method in accordance with a facsimile communication protocol signal transmitted from the recipient.

4. The color image communication device according to claim 2, wherein when color image data to be transmitted is under the second method, and the recipient supports both the first method and the second method, the means for controlling selects the first method as a color method for the transmission when printing out the color image data at the recipient, and selects the second method as a color method for the transmission when not printing out the color image data at the recipient.

5. The color image communication device according to claim 1, wherein the first method is a color method suitable for printing.

6. The color image communication device according to claim 1, wherein the first method is a CIELAB color method, and the second method is an sYCC color method.

7. The color image communication device according to claim 1, further comprising:
means for setting information of whether or not to print out the color image data at the recipient;
wherein the means for controlling determines whether or not to print out the color image data at the recipient in accordance with the information set by the means for setting.

8. The color image communication device according to claim 7, wherein the means for setting selects and sets whether or not to print out the color image data at the recipient by a selection operation of a user.

9. The color image communication device according to claim 7, wherein the means for setting can set the information of whether or not to print out the color image data at the recipient, in common for a plurality of transmission jobs.

10. The color image communication device according to claim 7, wherein the means for setting can individually set the information of whether or not to print out the color image data at the recipient for each transmission job.

11. The color image communication device according to claim 1, wherein when transmitting the color image data, in case the recipient does not have a color receiving ability, the means for controlling disconnects a communication line, and ends transmission processing.

12. The color image communication device according to claim 11, wherein the means for controlling determines whether or not the recipient has the color receiving ability in accordance with a facsimile communication protocol signal transmitted from the recipient.

13. The color image communication device according to claim 1, wherein the means for controlling determines whether to transmit the color image data under the first method or whether to transmit the color image data under the second method, in accordance with a determination of whether to print out the color image data at the recipient or whether to forward the color image data to another image processing device from the recipient.

14. The color image communication device according to claim 1, wherein the means for controlling notifies the recipient by a communication protocol signal of when transmitting the color image data to the recipient, whether or not to print out the received color image data.

15. The color image communication device according to claim 14, wherein the means for controlling notifies the recipient by a communication protocol signal of when transmitting the color image data to the recipient, whether to print out the received color image data or whether to forward to the received color image data to another image processing device.

16. The color image communication device according to claim 14, wherein the means for controlling notifies the recipient by designating a storage BOX by an F-CODE signal of the facsimile communication protocol, whether or not to print out the received color image data.

17. The color image communication device according to claim 1, further comprising:
means for storing a storage BOX number and information of whether or not to print out the received color image data by associating the storage BOX number and the information with one another;
wherein the means for controlling determines whether or not to print out the received color image data at the recipient in accordance with the storage BOX number designated at transmission, and in accordance with a result of the determination, the means for controlling determines whether to transmit the color image data under the first method or to transmit under the second method.

18. The color image communication device according to claim 1, wherein the means for controlling determines whether or not to print out the received color image data in accordance with a communication protocol signal of when receiving the color image data.

19. The color image communication device according to claim 1, wherein when a plurality of destination numbers are assigned to the recipient, the means for controlling instructs to the recipient by a destination number of when transmitting the color image data to the recipient, whether or not to print out the received color image data.

20. The color image communication device according to claim 19, wherein when the plurality of destination numbers are assigned to the recipient, the means for controlling instructs to the recipient by a destination number of when transmitting the color image data to the recipient, whether to print out the received color image data or whether to forward the received color image data to another image processing device.

21. The color image communication device according to claim 1, further comprising:
means for storing a destination number and information of whether or not to print out the received color image data by associating the destination number and the information with one another;
wherein the means for controlling determines whether or not print out the received color image data at the recipient in accordance with the input destination number, and in accordance with a result of the determination, the means for controlling determines whether to transmit the color image data under the first method or under the second method.

22. The color image communication device according to claim 1, wherein when a plurality of destination numbers are assigned to the color image communication device, the means for controlling determines whether or not to print out the received color image data in accordance with a destination number of when there is an incoming call.

23. The color image communication device according to claim 1, wherein the means for controlling instructs to the recipient by an extension attached to a destination number of when transmitting the color image data to the recipient, whether or not to print out the received color image data.

24. The color image communication device according to claim 23, wherein the means for controlling instructs to the recipient by the extension attached to the destination number of when transmitting the color image data to the recipient, whether to print out the received color image data, or whether to forward the received color image data to another image processing device.

25. The color image communication device according to claim 1, wherein when receiving color image data, the means for controlling determines whether or not to print out the received color image data in accordance with an extension attached to an incoming destination number.

26. The color image communication device according to claim 1, further comprising:
means for storing an extension to be attached to a destination number, and information of whether or not to print out the received color image data by associating the extension and the information with one another;
wherein the means for controlling determines whether or not to print out the received color image data at the recipient in accordance with an extension selected at the transmission, and in accordance with a result of the determination, the means for controlling determines whether to transmit the color image data under the first method or whether to transmit under the second method.

27. The color image communication device according to claim 1, wherein when a plurality of image communication devices are connected to a same communication line at the recipient, and a different destination number is applied to each of the image communication devices, the means for controlling instructs to the recipient by a destination number of when transmitting the color image data to the recipient, whether or not to print out the received color image data.

28. The color image communication device according to claim 27, wherein when the plurality of image communication devices are connected to the same communication line at the recipient, and a different destination number is applied to each of the image communication devices, the means for controlling instructs to the recipient by a destination number of when transmitting the color image data to the recipient, whether to print out the received color image data or whether to forward the received color image data to another image processing device.

29. The color image communication device according to claim 1, further comprising:
means for storing a destination number and information of whether or not to print out the received color image data by associating the destination number and the information with one another;
wherein the means for controlling determines whether or not to print out the received color image data at the recipient in accordance with the input destination number, and in accordance with a result of the determination, the means for controlling determines whether to transmit the color image data under the first method or under the second method.

30. The color image communication device according to claim 1, wherein when a color space of the received color image data is a color space which is not suitable for a post-reception processing function designated from a transmitter, the means for controlling notifies such a fact to the user.

31. The color image communication device according to claim 30, wherein after notifying the user, the means for controlling executes a processing of the received color image data in accordance with a command input by the user.

32. The color image communication device according to claim 30, wherein when the color space of the received color image data is CIELAB, and the post-reception processing function designated from the transmitter is a processing to forward the color image data to a remote image processing device, the means for controlling notifies such a fact to the user.

33. The color image communication device according to claim 30, wherein when the color space of the received color image data is sYCC, and the post-reception processing function designated from the transmitter is a printing processing, the means for controlling notifies such a fact to the user.

34. A color image communication device comprising:
means for carrying out a facsimile transmission of color image data as first color space data to a recipient;
means for carrying out a facsimile transmission of color image data as second color space data to the recipient;
means for converting the color image data of the second color space into the color image data of the first color space;
means for confirming a color space which can be supported by the recipient;
means for determining whether or not to print out the transmitted color image data at the recipient; and
means for switching to transmit the second color space data, or to transmit the first color space data converted from the second color space data, in accordance with a result of the confirmation of the color space which can be supported by the recipient, and a result of the determination of whether or not to print out the color image data at the recipient.

35. A color image communication device comprising:
means for scanning an original document optically and generating color image data of a Red, Green, Blue (RGB) color space;
means for storing color image data;
means for forwarding the color image data stored in the means for storing to a remote image processing device via a network;
means for printing the color image data stored in the means for storing on a recording paper;
means for converting the color image data of the RGB color space into a color space according to a processing to be carried out after the image is scanned; and
means for controlling, wherein when a forward processing by the means for forwarding is selected as a processing to be carried out after the image is scanned, the means for controlling converts the color image data of the RGB color space generated by the means for scanning into color image data of sYCC color space, and stores the color image data into the means for storing, and when a printing processing by the means for printing is selected as a processing to be carried out after the image is scanned, the means for controlling converts the color image data of the RGB color space generated by the means for scanning into color image data of CIELAB color space, and stores the color image data into the means for storing.

36. A color image communication device comprising:
a transmission unit which transmits color image data under a first method and a second method to a recipient; and
a control unit which determines whether to transmit the color image data under the first method or whether to transmit the color image data under the second method according to a determination of whether or not to print out the color image data at the recipient.
